(19) United States
(12) Patent Application Publication
(10) Pub. No.: US 2011/0295692 A1
(43) Pub. Date: Dec. 1, 2011

(54) Method of Using Location Information for Advertising System Based on 3-Dimensional Shapes

(75) Inventors: Aleksandar Zivkovic, North York (CA); Marvin Igelman, Thornhill (CA)

(73) Assignee: POYNT CORPORATION, Calgary (CA)

(21) Appl. No.: 13/117,211

(22) Filed: May 27, 2011

Related U.S. Application Data
(60) Provisional application No. 61/349,574, filed on May 28, 2010.

(51) Int. Cl. G06Q 30/00

(52) U.S. Cl. 705/14.58

(57) ABSTRACT

A method of delivering an advertisement to an electronic communications device via an electronic communications network includes obtaining, via the electronic communications network, a location of an electronic communications device, the location of the device corresponding to a longitude, a latitude, and an altitude of the communications device, accessing a database of advertisements, each advertisement in the database having an associated three-dimensional geographic region, identifying at least one advertisement in the database such that the location of the electronic communications device is within the associated three-dimensional geographic region of the advertisement, and delivering the advertisement to the electronic communications device via the electronic communications network.

### CROSS REFERENCE TO RELATED APPLICATIONS

This application claims the benefit of U.S. Provisional Patent Application No. 61/349,574, filed May 28, 2010, titled “Method of Using Location Information for Advertising System Based on 3-Dimensional Shapes,” the entire contents of which are hereby incorporated by reference herein, for all purposes.

### TECHNICAL FIELD

The present invention relates to delivering advertisements, and more particularly to delivering location-based advertisements over an electronic communications network.

### BACKGROUND ART

It is known in the prior art to deliver advertisements to electronic communications devices. It is further known to deliver targeted advertisements that are selected on the basis of information about the recipient of the advertisement. Such information may include the location of the recipient.

It is known to use geographic location for providing targeted advertisements. For example, during a national television broadcast, commercial breaks may include slots for local advertisements. In one media market, an advertisement for a local car dealer in the first market may be shown, while in another media market, an advertisement for a local supermarket in the second market may be shown. Geographically-targeted advertisements have been used for delivering advertisements to electronic communications devices, such as mobile telephones, as well. A mobile phone in Chicago may receive different advertising than a mobile phone in Miami. A mobile phone on the Upper West Side of Manhattan may receive different advertising than a mobile phone in Greenwich Village downtown.

### SUMMARY OF THE INVENTION

In a first embodiment of the invention there is provided a method of delivering an advertisement to an electronic communications device via an electronic communications network. The method includes obtaining, via the electronic communications network, a location of an electronic communications device. The location of the device corresponds to a longitude, a latitude, and an altitude of the communications device. The method also includes, in a first computer process, accessing a database of advertisements, each advertisement in the database having an associated three-dimensional geographic region. In a second computer process, at least one advertisement in the database is identified, such that the location of the electronic communications device is within the associated three-dimensional geographic region of the advertisement. The advertisement is delivered to the electronic communications device via the electronic communications network.

In a related embodiment of the invention, the method includes, in a third computer process, identifying at least two advertisements such that the location of the electronic communications device is within both of the associated three-dimensional geographic regions of the at least two advertisements. Advertisements in the database also have associated locations within the associated three-dimensional geographic region. The location of the advertisement corresponds to a longitude, a latitude and an altitude. The method further includes, in a fourth computer process, calculating a score for each of the at least two advertisements using the location of the advertisement and the location of the device. The advertisement having the best score is delivered to the electronic communications device via the electronic communications network.

In a further related embodiment, the method includes receiving a text query from the electronic communications device via the electronic communications network and calculating the score using the text query. Alternatively, or in addition, each advertisement may have an associated time period, such that the advertisement is not delivered outside of the associated time period.

In a further related embodiment, the method includes receiving a text query from the electronic communications device via the electronic communications network. In this case, calculating the score includes calculating the score using the text query.

In a further related embodiment, each advertisement also has an associated time period, such that the advertisement is not delivered outside of the associated time period.

In a further related embodiment, the method includes identifying at least one previously submitted text query, identifying a location associated with the previously submitted text query, identifying at least one advertisement that was delivered previously in response to the previously submitted text query for each of the at least one previously submitted text query, and for at least one of the previously delivered advertisements, identifying at least one action previously taken in response to the previously delivered advertisement. Calculating the score includes using at least one of the identified actions in calculating the score.

Another embodiment is another method of delivering an advertisement to an electronic communications device via an electronic communications network. The method includes obtaining a location of an electronic communications device via the electronic communications network. The location of the device corresponds to a longitude, a latitude, and an altitude. The method also includes, in a first computer process, providing the location of the electronic communications device to an advertisement server that has access to a database of advertisements. Each advertisement in the database has an associated three-dimensional geographic region. The method also includes, in a second computer process, receiving least one advertisement from the advertisement server. The advertisement is selected from the advertisements in the database such that the location of the electronic communications device is within the associated three-dimensional geographic region of the advertisement. The method also includes delivering the advertisement to the electronic communications device via the electronic communications network.

In a related embodiment of the invention, the method includes, in a third computer process, identifying at least two advertisements such that the location of the electronic communications device is within both of the associated three-dimensional geographic regions (shapes) of the at least two advertisements. Advertisements also have associated locations within the associated three-dimensional geographic region, and the location of the advertisement corresponds to a longitude, a latitude and an altitude. The method further includes, in a fourth computer process, calculating a score for each of the at least two advertisements using the location of the advertisement and the location of the device. The advertisement having the best score is delivered to the electronic communications device via the electronic communications network.

In a further related embodiment, the method includes receiving a text query from the electronic communications device via the electronic communications network, and calculating the score includes calculating the score using the text query. Alternatively, or in addition, each advertisement also has an associated time period, such that the advertisement is not delivered outside of the associated time period.

In a further related embodiment, the method includes identifying at least one previously submitted text query, identifying a location associated with the previously submitted text query, identifying at least one advertisement that was delivered previously in response to the previously submitted text query for each of the at least one previously submitted text query, and for at least one of the previously delivered advertisements, identifying at least one action previously taken in response to the previously delivered advertisement. Calculating the score includes using at least one of the identified actions in calculating the score.

Another embodiment of the invention is a computer program product, embodied in a tangible, non-transitory storage medium. The computer program product includes computer code for obtaining a location of an electronic communications device via the electronic communications network. The location of the device corresponds to a longitude, a latitude, and an altitude. The computer program product further includes computer code for accessing a database of advertisements. Each advertisement in the database has an associated three-dimensional geographic region. The computer program product further includes computer code for identifying at least one advertisement in the database such that the location of the electronic communications device is within the associated three-dimensional geographic region of the advertisement and computer code for delivering the advertisement to the electronic communications device via the electronic communications network.

In a related embodiment, the computer program product includes computer code for identifying at least two advertisements such that the location of the electronic communications device is within both of the associated three-dimensional geographic regions (shapes) of the at least two advertisements. Advertisements also have associated locations within the associated three-dimensional geographic region. The location of the advertisement corresponds to a longitude, a latitude and an altitude. The computer program product further includes computer code for calculating a score for each of the at least two advertisements using the location of the advertisement and the location of the device and computer code for delivering the advertisement having the best score to the electronic communications device via the electronic communications network.

In a further related embodiment, the computer program product includes computer code for receiving a text query from the electronic communications device via the electronic communications network. Calculating the score includes calculating the score using the text query. Alternatively, or in addition, each advertisement also has an associated time period, such that the advertisement is not delivered outside of the associated time period.

In a further related embodiment, the computer program product includes computer code for identifying at least one previously submitted text query, computer code for identifying a location associated with the previously submitted text query, computer code for identifying at least one advertisement that was delivered previously in response to the previously submitted text query for each of the at least one previously submitted text query, and computer code for identifying, for at least one of the previously delivered advertisements, at least one action previously taken in response to the previously delivered advertisement. Calculating the score includes calculating the score using at least one of the identified actions.

### BRIEF DESCRIPTION OF THE DRAWINGS

The foregoing features of the invention will be more readily understood by reference to the following detailed description, taken with reference to the accompanying drawings, in which:

FIG. 1 is a flowchart of a process for delivering an advertisement to an electronic communications device in accordance with an embodiment of the present invention.

FIG. 2 is a diagram of exemplary three-dimensional geographic regions that may be associated with advertisements in an embodiment of the present invention.

FIG. 3 is a diagram illustrating a practical implementation of an embodiment of the present invention.

### DETAILED DESCRIPTION OF SPECIFIC EMBODIMENTS

A major component of effective advertisement is proper targeting of advertising material. An advertisement that reaches mainly people who are unlikely to be interested in the subject of the advertisement is a waste of money. On the other hand, an advertisement that reaches mainly people who are likely to be interested is extremely valuable. One of the ways that advertisers target advertisements is geographically. Where a person is located may tell much about what kinds of products and services the person may be interested in, or to what kind of messaging the person may be susceptible. Prior art systems fail to recognize and exploit the benefits of targeting advertisements according to three-dimensional geographic location information.

Three-dimensional geographic location information allows for targeting ads with greater specificity than two-dimensional location-based techniques of the prior art. Different ads may be delivered to people who are located on different floors of a shopping mall, and thus may be chosen according to the shops on that particular floor. Different ads may be delivered to people on different floors of an office building, and thus different ads may be delivered to the people in the accounting firm on the fifteenth floor than are delivered to the people using the gym on the first floor, with the ads being chosen according to the different demographic audiences available in the different locations. Different ads may even be delivered to passengers in an airplane flying in the sky than are delivered to people walking on the ground below.

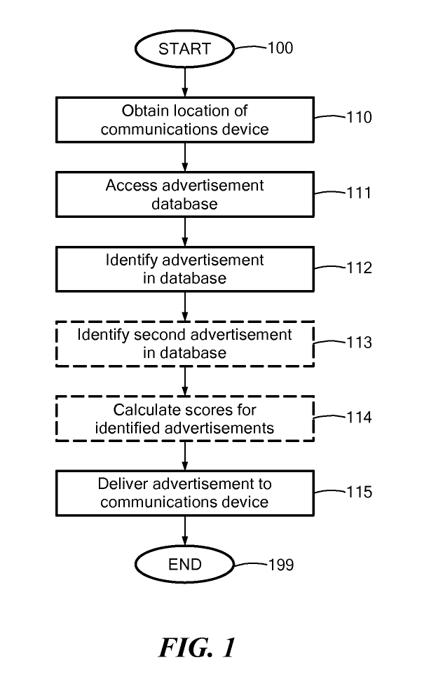

A process for delivering an advertisement to an electronic communications device is now described with reference to FIG. 1. The process begins at step 100. A user has an electronic communications device. Exemplary electronic communications devices include cell phones, personal digital assistants (PDAs), computers (laptop, desktop), etc. At step 110 a location of the electronic communications device is obtained. The location may advantageously be represented as a latitude, a longitude and an altitude. The location may be obtained via a GPS device. At step 111 an advertisement database is accessed. At step 112, an advertisement in the database is identified. The location of the electronic communications device is used in identifying the advertisement. In some embodiments, an advertisement may be identified only if the location of the electronic communications device is within a three-dimensional geographic advertisement region (also referred to herein as an advertisement volume) associated with the advertisement. Advertisement regions are discussed in greater detail below. In some embodiments, advertisements also may be limited to an associated time period. For example, delivery of a given advertisement may be restricted to taking place only between a predetermined start time and a predetermined end time. At optional step 113, a second advertisement in the database is identified. The second advertisement may be identified according to similar principles as used in identifying the first advertisement. In some embodiments, more than two advertisements may be identified. After optional step 113, optional step 114 is performed, in which scores are calculated for the identified advertisements. Further details of calculating scores are provided below. At step 115, an advertisement is delivered to the communications device. If optional steps 113 and 114 were performed, the advertisement to be delivered is selected from the identified advertisements based on the scores that were calculated. The advertisement having the best score may be delivered. In some embodiments multiple advertisements may be delivered, with the advertisements having the best scores being delivered. The order in which advertisements are delivered or the prominence with which the advertisements are displayed at the communications device may be determined according to the scores. The process ends at step 199.

The advertisement database contains advertisements for delivering to electronic communications devices. Each advertisement has an associated 3-dimensional geographic region (“advertisement region”) defining where the advertisement should be delivered. An advertisement region is a space such that every location (latitude, longitude and altitude), is either defined to be within the region or outside of the region.

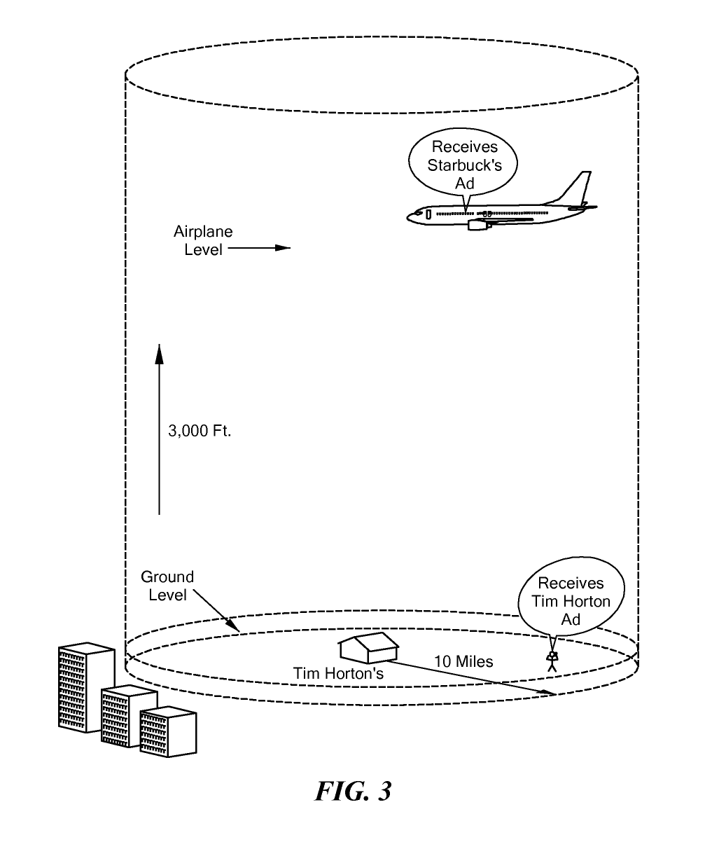

Advertisement regions may take any shape that will be useful. A cylinder is one example of a shape that may be useful for defining an advertisement region. For example, a business may buy an advertisement that may be delivered to any location that is between two altitudes x and y, so long as the latitude and longitude of the location fall within a cylinder with ends at altitudes x and y and of radius r centered at the place of operation of the business. An example of such an advertisement region is given below with reference to FIG. 3. Another example of a shape that may advantageously be employed as an advertisement region is a sphere. For example, a business may buy an advertisement that may be delivered to any location that is, in terms of absolute straight line distance, within a distance d from the place of business, thus defining a sphere of radius d as the advertisement region. Advertisement regions also may be defined according to cubes, cones, rectangular prisms, or any other shape that is desirable, including irregular shapes, such as shapes defined according to voting districts, or municipal or state borders. For example, an advertisement targeting apartment dwellers in a particular residential area regarding a message relating to issues such as rent control or tenants' rights may have an associated advertisement region that includes areas between 10 ft and 100 ft above street level in the targeted voting ward, because such a region would include mostly people residing in apartments, whereas locations at street level in the district might include many more people commuting through the area who do not reside there, but who may be interested in advertisements from local businesses instead.

Drawbacks to using 2-dimensional definitions of areas for local advertising may be appreciated when one takes into account the case of a user flying in an airplane. Such a situation is illustrated in FIG. 3. For example, a user may be flying in an airplane en route to the airport in Toronto. Modern airplanes may be equipped with in-plane internet access. The user may browse to a web page that displays a location-based advertisement. Alternatively, the user may use an application that displays a location-based advertisement. Because advertisements are selected for delivery according to advertisement regions in 3-dimensional space, the advertisements available for delivery at a particular latitude and longitude may vary based on altitude. For example, it is possible that a local Toronto Tim Hortons coffee shop has defined that they want their advertisement shown (or they have won a bidding war to have their advertisement shown) within a 10 mile radius of the store location, but only for people on the ground. In this case the 3-dimensional advertisement region may be defined by the radius around the store in terms of latitude and longitude and height of 10 feet from the ground.

In this same example, a Starbucks coffee shop at Pearson International airport in Toronto may have won the bid for the advertising rights for the same area as the Tim Hortons in terms of latitude and longitude, but for an altitude of 3000 ft. Such an advertising strategy could help to generate a caffeine craving in internet users arriving by airplane that will be satisfied by a visit to the Starbucks in the airport terminal once the plane lands. Therefore, a person walking on the street and using a mobile electronic communications device would receive the Tim Hortons advertisement and be encouraged to stop at the nearby Tim Hortons for coffee. The person in the airplane would receive the Starbucks advertisement and thus be encouraged to buy coffee in the airport terminal after landing. The latitude and longitude may be exactly the same for the two cases, but the different altitudes would cause the two users to be in different advertisement regions.

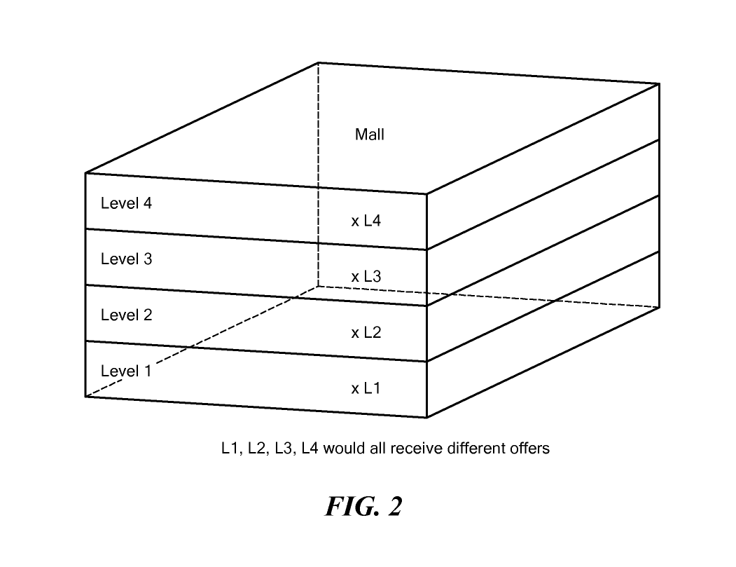

Another illustrative example is the case of a user who receives advertisements that are selected according to which floor of a multi-story building they are on. For example, a user on the ground floor may receiving an advertisement for a McDonalds restaurant that is in the lobby of the building. If the user is on the 23rd floor of the building, however, the user may receive an advertisement for a rotating restaurant located at the top of the building. In both of these cases, the latitude and longitude may be similar or even exactly the same, but due to the difference in altitude, different advertisement regions can be applicable. This situation is illustrated in FIG. 2. FIG. 2 shows four distinct locations, L1, L2, L3 and L4, which are on levels 1, 2, 3 and 4, respectively, of a shopping mall. The latitudes and longitudes of these locations are essentially the same, with only the altitude differing. The advertisements that are available for delivery may be different for each of these four locations. In this example, advertisement regions could be defined according to floors of the mall, such that one set of advertisements is available on level 1, a different set of advertisements is available on level 2, and so on. Other configurations are possible as well. For example, advertisement regions could be defined to cover multiple floors, such as (A) levels 1 and 2 together, (B) levels 2 and 3 together, and (C) levels 3 and 4 together. In this case, a communications device on level 1 would receive advertisements having advertisement region A, but a communications device on level 2 could receive advertisements having advertisement regions A or B. Similarly, a communications device on level 3 could receive advertisements having advertisement regions B or C, but a communications device on level 4 would receive advertisements just from advertisement region C.

Advertisement regions may partially or completely overlap. When advertisement regions overlap, and thus more than one advertisement is available for delivery to a location, several approaches are possible. In some embodiments, multiple advertisements may be delivered. Alternatively, the advertisement server may select which advertisement to delivery randomly. Another strategy is to determine a score for each advertisement that is available for delivery to the location, and to select the advertisement to be delivered according to the score.

A score is calculated for an advertisement relative to an electronic communications device having a known location. The score may be a calculated as a weighted sum of one or more elements or according to another scoring algorithm. According to an embodiment of the present invention, each advertisement has an associated location within the advertisement region. The associated location may be advantageously determined as a location of a business that is the subject of the advertisement. The score for an advertisement relative to a communications device, the device also having an associated location, may thus be the distance between the associated location of the communications device and the associated location of the advertisement, which may be equivalent to the distance from a user of the communications device to the business being advertised. The lower the score in this case, the closer the user is to the business, and thus the more effective the advertisement is likely to be. Instead of distance, other embodiments may use a measure of travel time to the associated location of the advertisement, which may be dependent on a measure of traffic congestion, differences in vertical travel speed relative to horizontal travel speed, etc. Thus, in some embodiments, a lower score is better than a higher score. In other embodiments, the opposite may be the case. For this reason, the terms “better,” “best,” “worse,” “worst” and the like are used herein to modify “score.”

Another factor that may be used in calculating a score is a velocity vector associated with the electronic communications device. In addition to the location of the communications device, a velocity vector indicating a present speed and direction of travel of the communications device can be used. Such a vector could be used, for example, in the case of the user in an airplane, discussed earlier. If only the 3D geographical location of a communications device in an airplane is known, it cannot be said for sure whether the user of the device is about to land in the nearby airport, or whether the user just recently departed from the nearby airport. This information can be ascertained readily by including the velocity vector in the analysis. Similarly, use of a velocity vector could be used to differentiate between potential local shoppers who are walking on foot at street level and commuters who are merely driving through the neighborhood on their way to their destination elsewhere.

A user of an electronic communications device may submit a query, e.g. to a search engine. Advertisements in the system may then be analyzed according to the query to determine a degree of relevance. The score may thus be further refined according to the degree of relevance to the query.

In response to advertisements received at the communications device, a user may take an action, such as clicking on the advertisement. User action in response to an advertisement can be recorded and stored in a database. User actions may be recorded in the advertisement database, or a separate database may be maintained for recording user actions. When a user submits a new query, information about previous actions taken by the user or by other users may be used in calculating a score for an advertisement. Previous queries by the user or by other users, similar to the present query, previous locations of users submitting the queries, and actions taken in response to advertisements that were provided, all may be used in determining a click-through probability for an advertisement, which may be used in determining a score for an advertisement. (“Click-through” means a user clicked an advertisement or in a portion of an advertisement and then completed a transaction (such as purchasing an item or reading a portion of a web page) advocated by the advertiser. The purchased item need not have been advertised in the advertisement that led to the click-through.) Factors used in determining an overall score for an advertisement may be combined in a weighted manner, which may be fine-tuned to provide appropriate significance to each factor.

As noted, the score may be calculated by a scoring algorithm that includes one or more elements, such as: distance, historical click-through rates, relevance, position within an application or web page and user targeting information. These elements are discussed below. Given a set of properties associated with an advertisement request, the scoring algorithm may attempt to maximize click-through rates or some other measurable advertisement metric, such as an action. Exemplary actions include click-to-call, click-to-map, click-to-add-to-contacts, click-to-browse, click-to-email and click-to-chat. The scoring algorithm may, for example, automatically adjust weights for the elements, so as to maximize the desired action.

Distance, such as between the user and the merchant, may be used as a parameter in its raw format, or it may be adjusted using a weighting function, which might be anisotropic, i.e., directionally dependent. For example, distance in the vertical direction might have less influence on the score than distance in a horizontal direction. Moreover, the adjustment might be different in different axes. The weights need not be applied linearly. That is, different weights may be applied to different ranges of distance values in order to account for a practical limit. For example, the significance of the vertical dimension may have significant drop-off beyond the height of a building, because distances beyond the building height would imply flying over the location. Thus, a weight of zero, or a very small value or progressively decreasing value, may be used for altitude values greater than a building's height.

Historical click-through rates may be used to generate a score that indicates likelihood that a user will click on an advertisement presented under conditions the same as, or very similar to, conditions under which the user or other users have clicked on this or a similar advertisement. For example, some tolerances could be given on the distance factors. The advertisement click-through rates are recorded, and historical averages may be taken over a predetermined time period. The time period may be another parameter that can be adjusted to increase performance of the model. The time period need not be the same for all types of advertisements. For example, advertisements associated with real-time applications might be better suited for shorter time periods whereas, in applications that use more static information, a longer time horizon for observing historical click-through rates might be more applicable.

Relevance may be calculated by comparing the advertisement content, category, keywords and other semantic metadata against the content and/or context of the application or web page, against which the advertisement might be served.

Some advertisements have been shown to perform better in particular positions within a web page or application. The position within an application or web page, against which the advertisement is being served or proposed to be served, may be used as a score-influencing factor. This factor is often used as a parameter within the historical click-through rates calculation.

A user targeting element may be calculated by comparing a user demographic profile, if available, against a desired demographic profile, as specified by an advertiser. In addition, if available, the user's behavioral information, such as information obtained through the user's browsing history or other sources of such information, such as user surveys, may be used by the scoring algorithm, such as by correlating this factor with the category of the advertisement.

Additional information about selecting advertisements for users, calculating prices to be charged to advertisers for the advertisements and related disclosure are provided in U.S. Provisional Patent Application No. 61/423,450, filed Dec. 15, 2010, titled “Price Formation in Location-Based Advertising Networks,” the entire contents of which are hereby incorporated by reference herein.

System and methods, as described herein, select and deliver advertisements to electronic communication devices of users, based on the three-dimensional geographic locations of the devices, and therefore the locations of the users, relative to locations that are relevant to the advertisements. The advertisements may be selected based on a score calculated from one or more elements. Thus, the advertisements are very likely to be highly relevant to the users, therefore increasing the likelihood that the users will click through the advertisements and/or make related purchases.

The embodiments of the invention described above are intended to be merely exemplary; numerous variations and modifications will be apparent to those skilled in the art. All such variations and modifications are intended to be within the scope of the present invention as defined in any appended claims.

In accordance with exemplary embodiments, a system and a method for delivering an advertisement to an electronic communications device via an electronic communications network are provided. Such a system may be implemented with computer instructions stored in a computer memory and a processor executing the instructions. Such a method may be performed by the processor. The memory may be random access memory (RAM), read-only memory (ROM), flash memory or any other memory, or combination thereof, suitable for storing control software or other instructions and data.

Some of the functions performed by the disclosed system and a method have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof. Those skilled in the art should also readily appreciate that instructions or programs defining the functions of the present invention may be delivered to a processor in many forms, including, but not limited to, information permanently stored on tangible, non-writable storage media (e.g. read-only memory devices within a computer, such as ROM, or devices readable by a computer I/O attachment, such as CD-ROM or DVD disks), information alterably stored on tangible, writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of, the illustrated embodiments may be made without departing from the inventive concepts disclosed herein. For example, although some aspects of system and method have been described with reference to a flowchart, those skilled in the art should readily appreciate that functions, operations, decisions, etc. of all or a portion of each block, or a combination of blocks, of the flowchart may be combined, separated into separate operations or performed in other orders. Furthermore, disclosed aspects, or portions of these aspects, may be combined in ways not listed above. Accordingly, the invention should not be viewed as being limited to the disclosed embodiments.

What is claimed is:

1. A method of delivering an advertisement to an electronic communications device via an electronic communications network, the method comprising:
obtaining, via the electronic communications network, a location of an electronic communications device, the location of the device corresponding to a longitude, a latitude, and an altitude of the communications device;
in a first computer process, accessing a database of advertisements, each advertisement in the database having an associated three-dimensional geographic region;
in a second computer process, identifying at least one advertisement in the database such that the location of the electronic communications device is within the associated three-dimensional geographic region of the advertisement; and
delivering the advertisement to the electronic communications device via the electronic communications network.

2. The method of claim 1, wherein advertisements in the database also have an associated location within the associated three-dimensional geographic region, the location of the advertisement corresponding to a longitude, a latitude, and an altitude, the method further comprising:
in a third computer process, identifying at least two advertisements such that the location of the electronic communications device is within both of the associated three-dimensional geographic regions of the at least two advertisements;
in a fourth computer process, calculating a score for each of the at least two advertisements using the location of the advertisement and the location of the device; and
delivering the advertisement having the best score to the electronic communications device via the electronic communications network.

3. The method of claim 2, further comprising:
receiving a text query from the electronic communications device via the electronic communications network;
wherein calculating the score includes calculating the score using the text query.

4. The method of claim 1, wherein each advertisement also has an associated time period, such that the advertisement is not delivered outside of the associated time period.

5. The method of claim 3, further comprising:
identifying at least one previously submitted text query;
identifying a location associated with the previously submitted text query;
for each of the at least one previously submitted text query, identifying at least one advertisement that was delivered previously in response to the previously submitted text query; and
for at least one of the previously delivered advertisements, identifying at least one action previously taken in response to the previously delivered advertisement;
wherein calculating a score includes calculating a score using at least one of the identified actions.

6. A method of delivering an advertisement to an electronic communications device via an electronic communications network, the method comprising:
obtaining, via the electronic communications network, a location of an electronic communications device, the location of the device corresponding to a longitude, a latitude, and an altitude;
in a first computer process, providing the location of the electronic communications device to an advertisement server, the advertisement server having access to a database of advertisements, each advertisement in the database having an associated three-dimensional geographic region;
in a second computer process, receiving from the advertisement server at least one advertisement, selected from the advertisements in the database, such that the location of the electronic communications device is within the associated three-dimensional geographic region of the advertisement; and
delivering the advertisement to the electronic communications device via the electronic communications network.

7. The method of claim 6, wherein advertisements also have associated locations within the associated three-dimensional geographic region, the location of the advertisement corresponding to a longitude, a latitude, and an altitude, the method further comprising:
in a third computer process, identifying at least two advertisements such that the location of the electronic communications device is within both of the associated three-dimensional geographic regions of the at least two advertisements;
in a fourth computer process, calculating a score for each of the at least two advertisements using the location of the advertisement and the location of the device; and
delivering the advertisement having the best score to the electronic communications device via the electronic communications network.

8. The method of claim 7, further comprising:
receiving a text query from the electronic communications device via the electronic communications network;
wherein calculating the score includes calculating the score using the text query.

9. The method of claim 8, wherein each advertisement also has an associated time period, such that the advertisement is not delivered outside of the associated time period.

10. The method of claim 8, further comprising:
identifying at least one previously submitted text query;
identifying a location associated with the previously submitted text query;
for each of the at least one previously submitted text query, identifying at least one advertisement that was delivered previously in response to the previously submitted text query; and
for at least one of the previously delivered advertisements, identifying at least one action previously taken in response to the previously delivered advertisement;
wherein calculating a score includes calculating a score using at least one of the identified actions.

11. A computer program product, embodied in a tangible, non-transitory storage medium, the computer program product comprising:
computer code for obtaining, via the electronic communications network, a location of an electronic communications device, the location of the device corresponding to a longitude, a latitude, and an altitude;
computer code for accessing a database of advertisements, each advertisement in the database having an associated three-dimensional geographic region;
computer code for identifying at least one advertisement in the database such that the location of the electronic communications device is within the associated three-dimensional geographic region of the advertisement; and
computer code for delivering the advertisement to the electronic communications device via the electronic communications network.

12. The computer program product of claim 11, wherein advertisements also have associated locations within the associated three-dimensional geographic region, the location of the advertisement corresponding to a longitude, a latitude, and an altitude, and the computer program product further comprises:
computer code for identifying at least two advertisements such that the location of the electronic communications device is within both of the associated three-dimensional geographic regions of the at least two advertisements;
computer code for calculating a score for each of the at least two advertisements using the location of the advertisement and the location of the device; and
computer code for delivering the advertisement having the best score to the electronic communications device via the electronic communications network.

13. The computer program product of claim 12, further comprising:
computer code for receiving a text query from the electronic communications device via the electronic communications network;
wherein calculating the score includes calculating the score using the text query.

14. The computer program product of claim 13, wherein each advertisement also has an associated time period, such that the advertisement is not delivered outside of the associated time period.

15. The computer program product of claim 13, further comprising:
computer code for identifying at least one previously submitted text query;
computer code for identifying a location associated with the previously submitted text query;
computer code for identifying, for each of the at least one previously submitted text query, at least one advertisement that was delivered previously in response to the previously submitted text query; and
computer code for identifying, for at least one of the previously delivered advertisements, at least one action previously taken in response to the previously delivered advertisement;
wherein calculating the score includes calculating the score using at least one of the identified actions.
